(19) United States
(12) Patent Application Publication
(10) Pub. No.: US 2016/0375924 A1
(43) Pub. Date: Dec. 29, 2016

(54) STEERING WHEEL WITH INTEGRATED KEYBOARD ASSEMBLY

(71) Applicant: STEERING SOLUTIONS IP HOLDING CORPORATION, Saginaw, MI (US)

(72) Inventors: Joen C. Bodtker, Gaines, MI (US); Todd M. King, Saginaw, MI (US); Frank P. Lubischer, Commerce Township, MI (US); Richard P. Nash, Frankenmuth, MI (US); Melvin L. Tinnin, Clio, MI (US); Christopher F. Watz, Bay City, MI (US)

(21) Appl. No.: 15/191,002

(22) Filed: Jun. 23, 2016

Related U.S. Application Data
(60) Provisional application No. 62/184,592, filed on Jun. 25, 2015.
(60) Provisional application No. 62/248,550, filed on Oct. 30, 2015.

(51) Int. Cl. B62D 1/04; B60K 35/00; B60R 11/02; B62D 1/10

(52) U.S. Cl. CPC B62D 1/046; B62D 1/10; B60K 35/00; B60R 11/0229; B60R 11/0252; B60K 2350/1024; B60K 2350/1056; B60K 2350/928; B60R 2011/001

(57) ABSTRACT

A steering wheel for a vehicle includes a steering wheel hub. Also included is a first portion of the steering wheel hub having an electronic display. Further included is a second portion of the steering wheel hub having a keyboard, the keyboard being in operable communication with the electronic display.

### CROSS REFERENCE TO RELATED APPLICATION

This patent application claims priority to U.S. Provisional Patent Application Ser. No. 62/184,592, filed Jun. 25, 2015, and U.S. Provisional Patent Application Ser. No. 62/248,550, filed Oct. 30, 2015, each of which is incorporated herein by reference in its entirety.

### BACKGROUND OF THE INVENTION

The embodiments described herein relate to steering wheel assemblies.

As autonomously driven vehicles are developed, a number of opportunities will evolve related to entertainment and functionality for drivers. Steering wheels are commonly limited to standard driving positions due to the need for a driver to handle the steering wheel during operation of the vehicle. These limitations may be unnecessary during an autonomous driving mode of a vehicle.

### SUMMARY OF THE INVENTION

According to one aspect of the invention, a steering wheel for a vehicle includes a steering wheel hub. Also included is a first portion of the steering wheel hub having an electronic display. Further included is a second portion of the steering wheel hub having a keyboard, the keyboard being in operable communication with the electronic display.

According to another aspect of the invention, a keyboard assembly for an autonomous vehicle includes a steering wheel hub. Also included is a keyboard integrated with the steering wheel hub, the keyboard moveable between a retracted position and a deployed position, the keyboard disposed within a recess of the steering wheel hub in the retracted position and positioned for use by a vehicle occupant in the deployed position.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a steering wheel having a keyboard assembly in a first position according to one aspect of the disclosure;

FIG. 2 is a perspective view of the keyboard assembly of FIG. 1 in a second position;

FIG. 2A is a perspective view of a virtual keyboard assembly;

FIG. 3 is a perspective view of the steering wheel having the keyboard assembly according to another aspect of the disclosure, the keyboard assembly disposed in a retracted position;

FIG. 4 is a perspective view of the keyboard assembly in a first partially deployed position;

FIG. 5 is a perspective view of the keyboard assembly in a second partially deployed position;

FIG. 6 is a perspective view of the keyboard assembly;

FIG. 7 is a perspective view of the keyboard assembly in a fully deployed and locked position;

FIG. 8 is a perspective view of the keyboard assembly in a deployed and unlocked position;

FIG. 9 is a perspective view of the keyboard assembly during rotation thereof;

FIG. 10 is a perspective view of the keyboard assembly in a fully rotated and unlocked position;

FIG. 11 is a perspective view of the keyboard assembly in a fully rotated and locked position;

FIG. 12 is a perspective view of the steering wheel with a hub recess cover in a first position;

FIG. 13 is a perspective view of the hub recess cover in a second position;

FIG. 14 is a perspective view of a portable electronic device coupled to the hub recess cover;

FIG. 15 is a perspective view of a lock assembly of the keyboard assembly;

FIG. 16 is a perspective view of the hub recess cover having a stylus pocket;

FIG. 17 is a perspective view of the stylus pocket having a retaining feature;

FIG. 18 is a side, elevation view of the keyboard assembly in a first deployed position;

FIG. 19 is a side, elevation view of the keyboard assembly in a second deployed position;

FIG. 20 is a side, elevation view of the keyboard assembly in the first deployed position with relative angles of components shown; and

FIG. 21 is a side, elevation view of the keyboard assembly in the second deployed position with relative angles of components shown.

### DETAILED DESCRIPTION

Referring to the Figures, where the invention will be described with reference to specific embodiments, without limiting same, a keyboard assembly for a steering wheel is provided. The keyboard assembly is integrated with the steering wheel to provide a readily accessible keyboard for a vehicle operator. Such control is advantageous in a vehicle when the steering wheel is not required to steer the vehicle, such as when the vehicle is parked or in a vehicle that is capable of operating in an autonomous driving mode.

Autonomous driving refers to vehicles that are configured to perform operations without continuous input from a driver (e.g., steering, accelerating, braking etc.) and may be equipped with Advanced Driver Assist System (ADAS) to allow the vehicle to be autonomously controlled using sensing, steering, and/or braking technology. When an autonomous steering system is activated, the steering wheel is not required for vehicle control and, therefore, the vehicle provides opportunities for a driver to use the steering wheel as a workspace, for example.

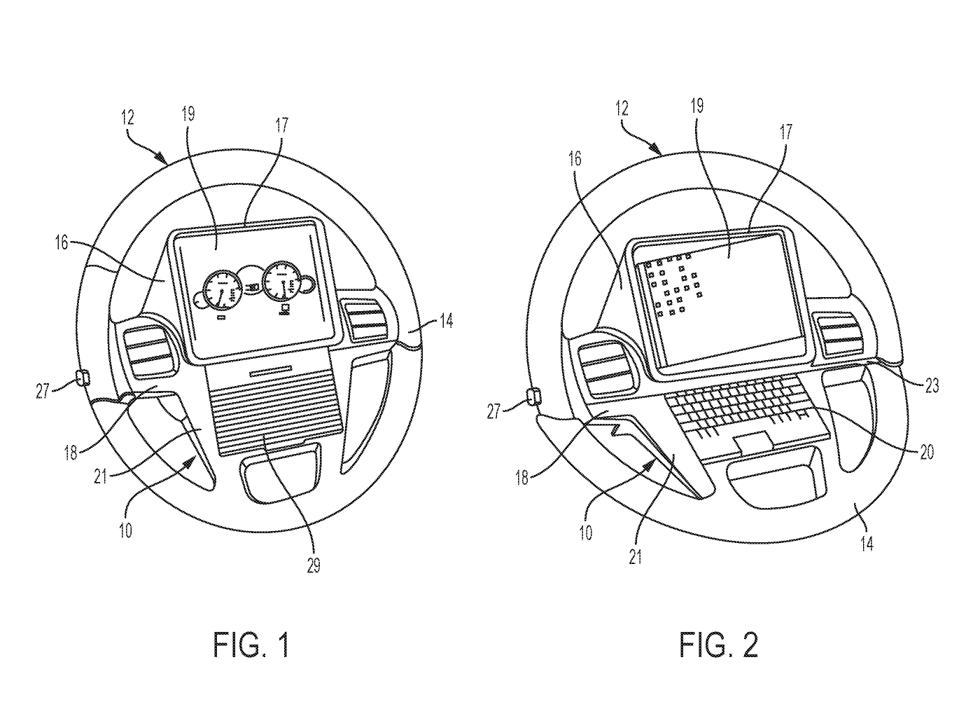

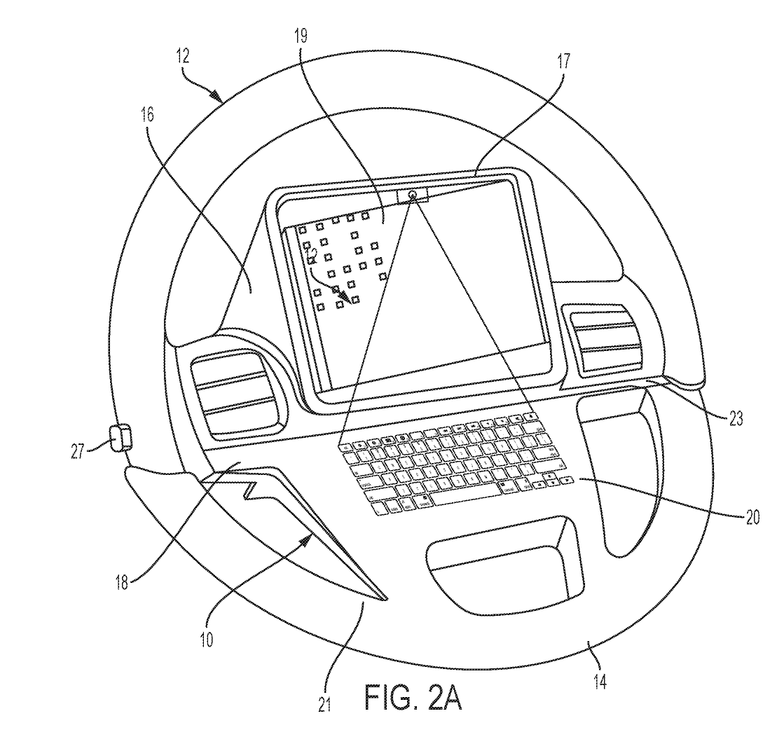

Referring now to FIGS. 1 and 2, a steering wheel 12 is shown with an outer handle 14, a hub 16 and at least one spoke 18 connecting the outer handle 14 and the hub 16. It is to be appreciated that there are numerous types of steering wheel configurations and the illustrated type is not limiting of the steering wheels which may benefit from embodiments of the keyboard assembly described herein.

Irrespective of the particular type of steering wheel configuration, the hub 16 includes a keyboard assembly 10 integrated therewith. Reference to an integrated keyboard assembly differs from a keyboard that is easily coupled to the steering wheel 12, such as in a clipped on manner. The integrated assembly of the keyboard assembly 10 with the hub 16 provides a more permanent connection that allows the keyboard assembly 10 to be moved between a retracted position and a deployed position.

In the illustrated embodiment, the hub 16 includes a first portion 17 with an electronic display 19 and a second portion 21 with a keyboard 20. The keyboard 20 is in electronic operable communication with the display 19 such that inputs selected on the keyboard 20 are reflected on the electronic display 19. The keyboard 20 can have physical keys or can be a virtual keyboard projected and/or displayed on a touch-screen (FIG. 2A), for example.

The second portion 21 is repositionable relative to the first portion 17 at least between a first position (FIG. 1) and a second position (FIG. 2). The relative movement between the second portion 21 and the first portion 17 is by pivotal rotation about a hinge 23 in some embodiments. The first portion 17 and the second portion 21 each define a plane and the planes are substantially coplanar when the second portion 21 is in the first position and are not coplanar when the second portion 21 is not in the first position. Further, the plane defined by the second portion 21 is nearer to horizontal when in the second position relative to when it is in the first position. This nearer to horizontal orientation of the second portion 21 when in the second position orients the keyboard 20 in a position that makes entering data via the keyboard 20 more ergonomically desirable to use for an operator.

A position releaser 27, illustrated as a button in FIGS. 1 and 2, is used to unlock the hinge 23 to allow the second portion 21 to rotate relative to the first portion 17. Depressing the button 27 disengages a lock mechanism. The button 27 is spring loaded such that it automatically returns to a locking position when a finger that has depressed the button 27 is released therefrom. The lock mechanism in one embodiment provides a plurality of positions over a positional range, wherein the second portion 21 is lockably positioned relative to the first portion 17.

The steering wheel 10 also includes a cover 29 for covering or hiding the keyboard 20 when the cover 29 is in a closed position (FIG. 1) and uncovers or exposes the keyboard 20 when the cover 29 is in the open position (FIG. 2). The cover 29 in one embodiment is slidable to a hidden position in a fashion similar to a roll-top desk. Such a configuration allows the cover 29 to remain attached to the steering wheel 12 whether the cover 29 is in the open or closed position and to be concealed from view when the cover 29 is in the open position.

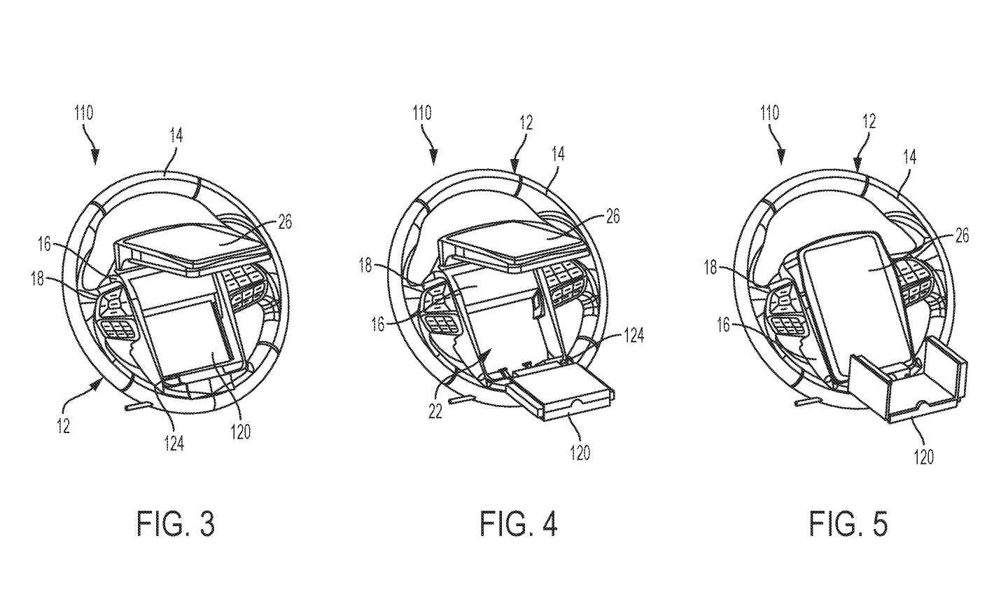

Referring now to FIGS. 3-5, another aspect of the disclosure is illustrated. In particular, a keyboard assembly 110 is shown according to another embodiment that allows the keyboard 20 to be moved between a retracted position and a deployed position. In the retracted position (FIG. 3), a keyboard 120 is positioned relative to the hub 16 in a manner that does not impede a driver during operation of the vehicle in a non-autonomous driving mode. Although illustrated as being disposed within a recess 22 (e.g., pocket) of the hub 16 in the retracted position, it is to be understood that the keyboard 120 may be manipulated to be stored in an alternative manner. In the illustrated embodiment, the keyboard 120 is rotated between the retracted position and the deployed position about a hinge region 124. Alternatively, the keyboard 120 may be primarily translated (e.g., slid) between the retracted and deployed positions in some embodiments. In yet further embodiments, a combination of rotation and translation are employed.

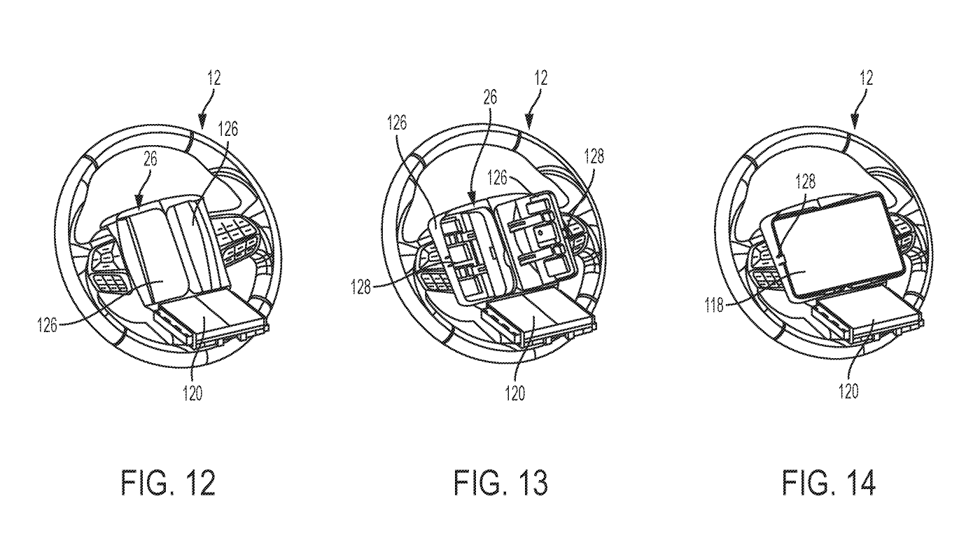

As shown, a hub recess cover 26 may be included to moveably cover the keyboard when in the retracted position. In the illustrated embodiment, the hub recess cover 26 is rotated out of the way to allow deployment of the keyboard 120, then rotated once more into its original position once deployment is completed. In some embodiments, the hub recess cover 26 is a visual interface that interacts with the keyboard, such as the electronic display 18 of the previously described embodiment. For example, a tablet or monitor may be integrated with the hub recess cover 26 and is available for use when the vehicle is in an autonomous driving mode. Alternatively, a portable electronic device 118 (FIG. 14) provides a visual interface that works with the keyboard 120 and may be detachably coupled to the steering wheel 12, such as in a clipped on manner. For example, an electronic device may be attached to the hub recess cover 26 in the orientation shown in FIGS. 3-5. Alternatively, the hub recess cover 26 includes at least one panel 126 that pivots or slides to an open position to receive the electronic device 118, as shown in FIGS. 12-14. In the embodiment illustrated in FIGS. 12-14, two panels 126 are included and one or both of the panels includes at least one retention feature 128 that secures the portable electronic device 118 thereto.

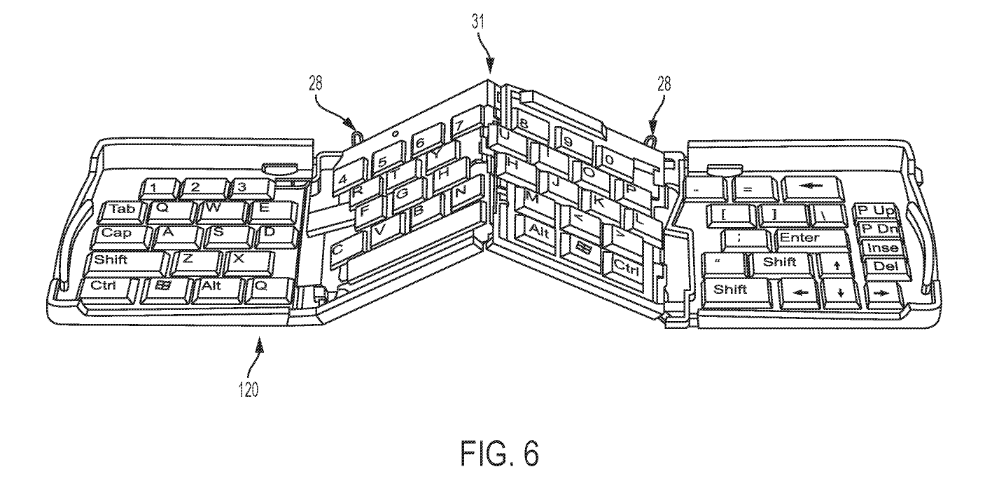

FIGS. 4 and 5 illustrate the keyboard 120 at different stages in the deployment process. As shown, the keyboard 120 is rotated away from the hub recess cover 26 to a position that is accessible for use by the user. As shown in FIGS. 5 and 6, in some embodiments, the keyboard 120 is a foldable keyboard that is foldable between a collapsed condition and an expanded position. In such embodiments, the foldable nature of the keyboard 120 allows the keyboard to fit within the recess 22 more efficiently in some steering wheel configurations.

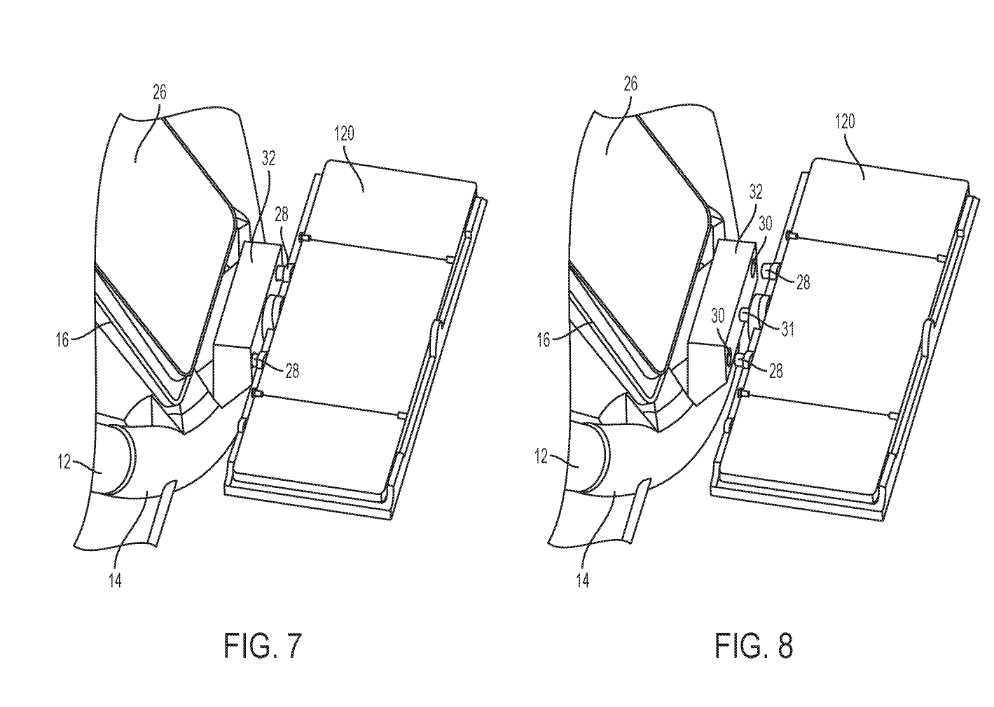

Referring now to FIGS. 6-8, adjustment of the keyboard 120 is illustrated. In particular, FIG. 7 illustrates the keyboard 120 in a fully deployed and locked position. As described above, the fully deployed position refers to a position that enables a user to type on the keyboard in a comfortable manner. The keyboard 120 is lockable in this position to reduce the likelihood of inadvertent maneuvering of the keyboard 120. The keyboard 120 is locked into place with at least one locking pin 28 operatively coupled to the keyboard 120. In the illustrated embodiment, two locking pins are shown, but it is to be appreciated that more or fewer pins may be employed. The keyboard 120 includes a spring biased component 31 biased outwardly from the keyboard 120 toward a position that facilitates engagement of the locking pin(s) 28 with a corresponding aperture 30 of a structure 32 operatively coupled to the steering wheel 12. As shown in FIG. 8, the locking pin(s) 28 are retracted out of the corresponding aperture 30 when the biasing force exerted by the spring biased component 31 is overcome. The spring force must be overcome to place the spring into compression to withdraw the pin(s) 28 from the aperture(s) 30. Upon letting go of the keyboard by a user, the spring force exerted by the spring biased component 31 biases the keyboard 120 toward the hub 16 to reengage the pin(s) 28 with the aperture(s) 30.

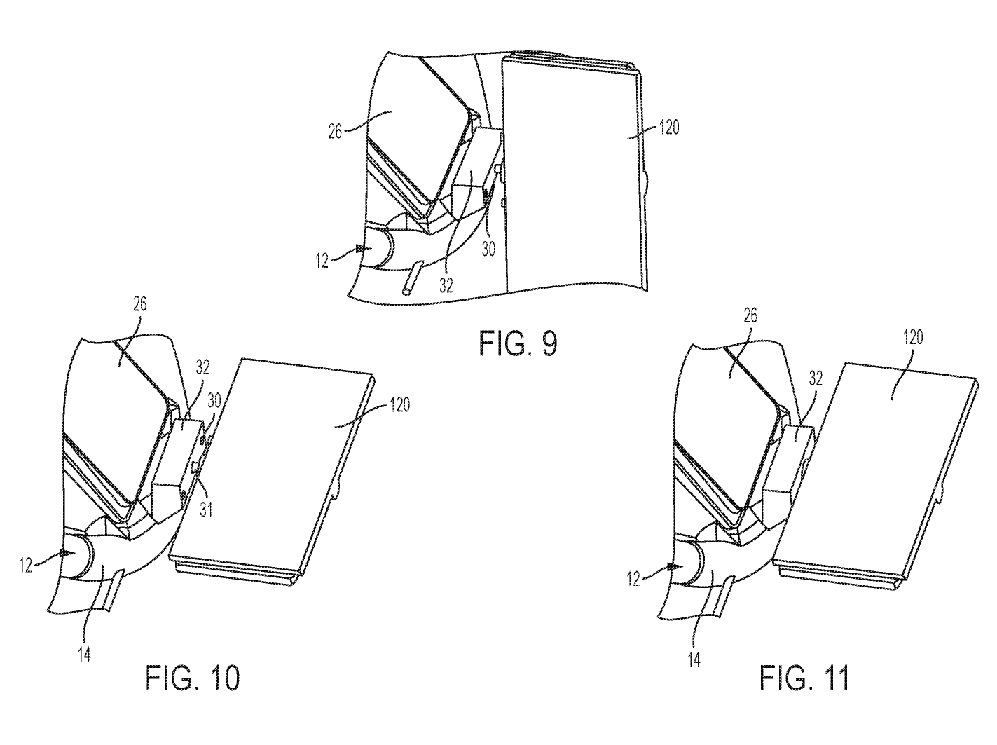

Referring now to FIGS. 9-11, further adjustability of the keyboard 20 is illustrated. Once in the unlocked position described above (i.e., locking pin 28 withdrawn from aperture 30), the keyboard 120 is free to pivot about an axis that allows for counterclockwise and/or counterclockwise rotation of the keyboard 120. Such rotation allows for an underside of the keyboard 120 to be accessible to the vehicle operator. The underside of the keyboard 120 may be utilized as a tray that may be used as an armrest or a surface upon which objects may be placed. Once the rotation to the tray configuration is achieved, the locking pin(s) 28 is biased back into engagement with the aperture 30 to lock the keyboard 120 in place once again. As one can appreciate, the unlocking process may be conducted once more to rotate the keyboard 120 back into a keyboard configuration, as desired.

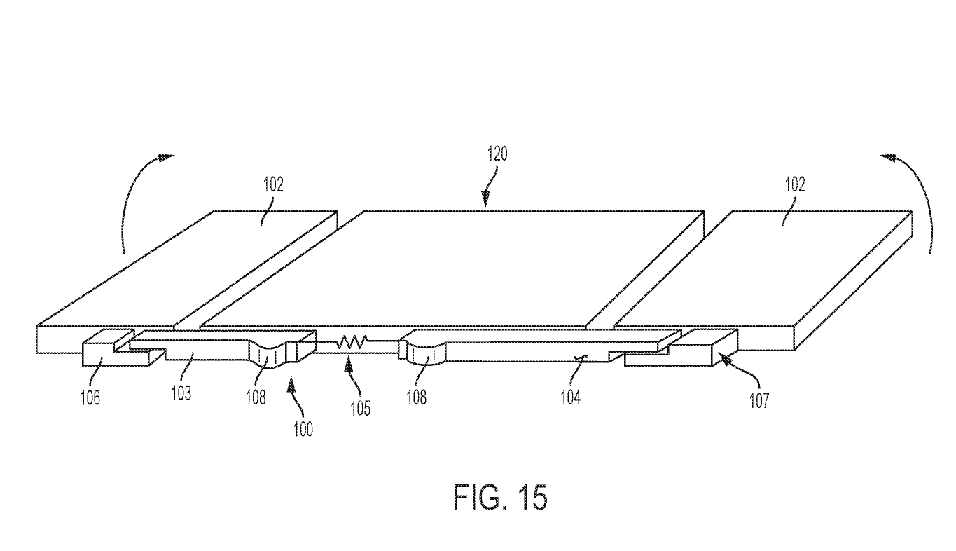

Referring to FIG. 15, a lock assembly 100 is illustrated. The lock assembly 100 is provided to ensure that the keyboard 120, in embodiments where foldable, remains a planar member irrespective of the configuration it is disposed in. In particular, foldable panels 102 of the keyboard 120 would be prone to succumb to gravity when rotated from a keyboard accessible position to a tray position. The lock assembly 100 counteracts the gravitational force by locking the foldable panels 102. The lock assembly 100 includes a first lock bolt 103 and a second lock bolt 104 operatively coupled to each other, and biased away from each other, with a separating spring 105. The lock bolts 103, 104 are positioned to engage respective locking sockets 106, 107 in the biased condition. Engagement of the lock bolts 103, 104 with the locking sockets 106, 107 resist folding of the foldable panels 102 of the keyboard 120 due to the spring force. In some embodiments, each lock bolt 103, 104 includes a pinch tab 108 that provides gripping locations for a user to pull the lock bolts 103, 104 together to allow the foldable panels 102 to be rotated in preparation for stowing the keyboard 120.

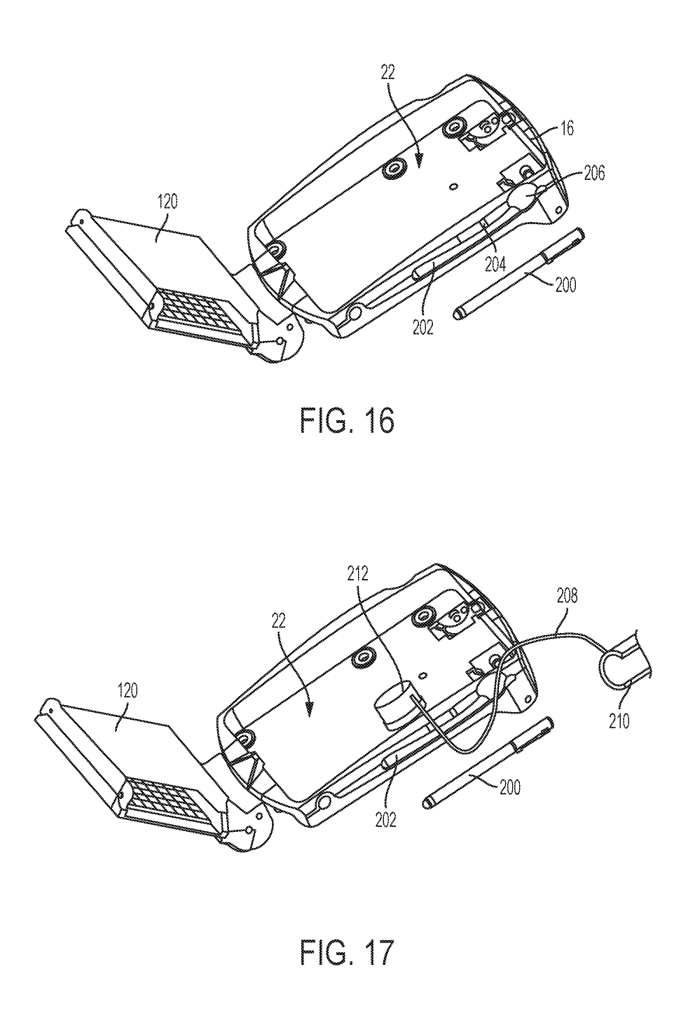

Referring to FIGS. 16, some electronic devices benefit from the use of a stylus 200 to carry out various operations on the device. To accommodate such devices, the hub 16 of the steering wheel 12 includes a stylus pocket 202 in some embodiments. The stylus pocket 202 is a recessed portion of the hub 16 that is dimensioned to securely retain the stylus 200 at least partially therein. In the illustrated embodiment, the stylus pocket 202 is located on a side portion of the hub 16, but it is to be appreciated that alternative locations are contemplated. Additionally, multiple stylus pockets may be provided on the hub 16, such as on each side of the hub 16 to accommodate left and right handed users. A snap retention feature 204 located at least partially within the stylus pocket 202 is present to retain the stylus 200 therein. For ease of insertion and removal of the stylus 200, a grasp relief portion 206 is included in some embodiments in the form of a recess at the top or bottom of the stylus pocket 202.

As shown in FIG. 17, a tether 208 may be operatively coupled to the stylus pocket 202 to allow the stylus 200 to be coupled thereto. Use of the tether 208 reduces the likelihood of dropping or losing the stylus 200. In such embodiments, a stylus clasp 210 is located at one end of the tether 208 to securely retain the stylus 200 thereto. In some embodiments, the other end of the tether 208 is operatively coupled to a retracting mechanism 212 to allow automatic retraction of the tether 208, and stylus 200, toward the stylus pocket 202. For example, the tether 208 is a spring retractable tether in some embodiments.

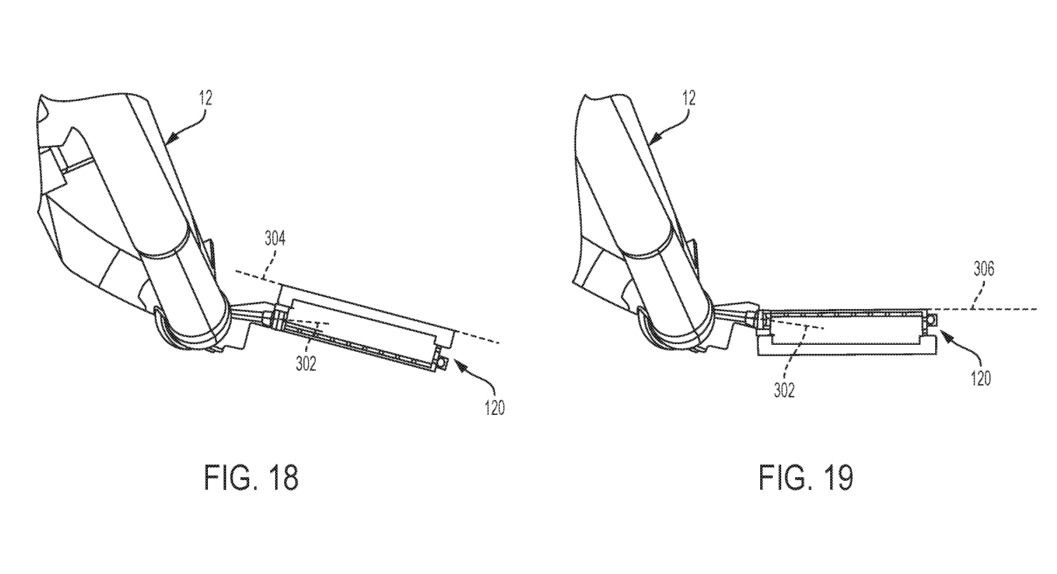

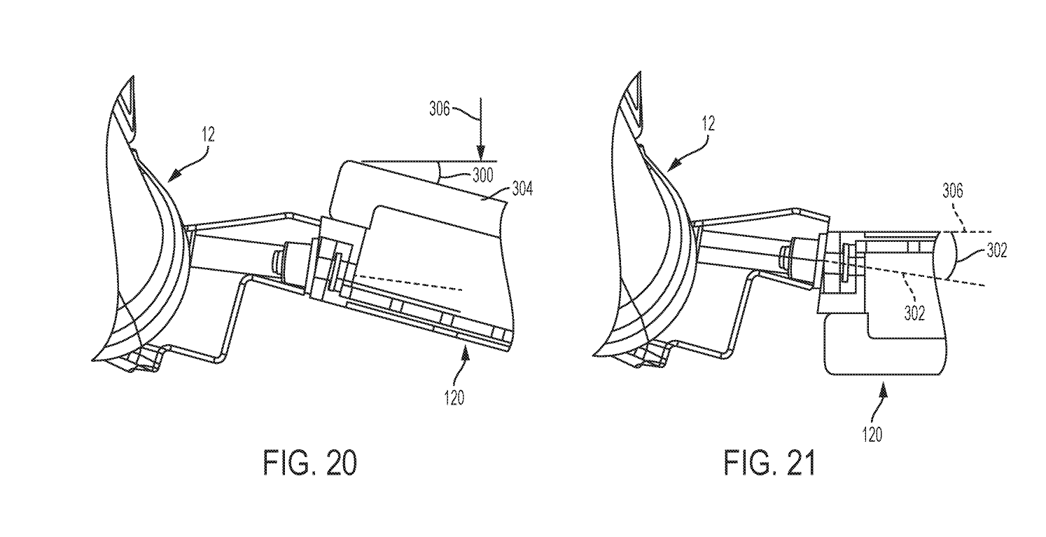

Referring now to FIGS. 18-21, the keyboard assembly 110 is illustrated to show another aspect of the disclosure. FIGS. 18 and 20 depict the keyboard 120 in a keyboard accessible position for a user and FIGS. 19 and 21 depict the keyboard 120 in a tray (or table) accessible position. In most situations, a user will desire to have the tray in a substantially horizontal position to provide a flat surface for writing, resting one's arms, etc. However, a non-horizontal orientation of the keyboard 120 is typically considered more ergonomically desirable for keystroke input, such that the keyboard accessible position should be at an angle 300 that is offset from horizontal, as shown. In some embodiments, the offset angle 300 ranges from about 10 degrees to about 20 degrees, but other angles are contemplated.

To achieve the different angular orientations of the keyboard 120 described above, the spin axis of the keyboard 120 is canted to provide a cant angle 302. In particular, the cant angle 302 does not coincide with the keyboard surface plane 304 or the tray surface plane 306. In some embodiments, the cant angle 302 is one-half of the angle 300. In other words, the spin axis of the keyboard 120 is about one-half of the angle 300 that the keyboard is offset from horizontal. The cant angle 302 may be modified based on the particular needs of various specific applications.

Advantageously, an integrated keyboard assembly, and associated features, is provided for an autonomous vehicle steering wheel to allow a vehicle operator to utilize a keyboard or tray, as desired, during operation of the vehicle in an autonomous mode or in a parked condition. The integrated assembly reduces the effort associated with coupling and decoupling a stand-alone keyboard to a steering wheel.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering wheel for a vehicle comprising:
a steering wheel hub;
a first portion of the steering wheel hub having an electronic display; and
a second portion of the steering wheel hub having a keyboard, the keyboard being in operable communication with the electronic display.

2. The steering wheel of claim 1, wherein the second portion of the steering wheel is repositionable relative to the first portion between a first position and a second position.

3. The steering wheel of claim 2, wherein the second portion is coplanar with the first portion when the first portion is in the first position and is not coplanar when the second portion is in the second position.

4. The steering wheel of claim 2, wherein the second portion is rotatable.

5. The steering wheel of claim 1, wherein the keyboard is a virtual keyboard.

6. The steering wheel of claim 1, further comprising a cover moveable between a closed position and an open position, wherein the cover hides the keyboard when in the closed position and exposes the keyboard when in the open position.

7. The steering wheel of claim 6, wherein the cover remains attached to the steering wheel while in both the closed position and the open position.

8. The steering wheel of claim 1, further comprising a stylus pocket defined by a portion of the steering wheel hub, the stylus pocket dimensioned to retain a stylus therein.

9. A keyboard assembly for an autonomous vehicle comprising:
a steering wheel hub; and
a keyboard integrated with the steering wheel hub, the keyboard moveable between a retracted position and a deployed position, the keyboard disposed within a recess of the steering wheel hub in the retracted position and positioned for use by a vehicle occupant in the deployed position.

10. The keyboard assembly of claim 9, wherein the keyboard is covered by a hub recess cover when in the retracted position.

11. The keyboard assembly of claim 10, wherein the hub recess cover includes at least one retention feature to secure a portable electronic display thereto in a portrait orientation.

12. The keyboard assembly of claim 10, wherein the hub recess cover comprises a plurality of panels, the panels including respective retention features and moveable to secure a portable electronic display thereto in a landscape orientation.

13. The keyboard assembly of claim 9, further comprising a stylus pocket defined by a portion of the steering wheel hub, the stylus pocket dimensioned to retain a stylus therein, the stylus coupled to the stylus pocket with a tether.

14. The keyboard assembly of claim 9, wherein the keyboard is a foldable keyboard having a main portion and at least one foldable panel.

15. The keyboard assembly of claim 14, further comprising a lock assembly operatively coupled to the foldable keyboard to retain the at least one panel and the main portion in a single plane.

16. The keyboard assembly of claim 15, wherein the lock assembly comprises:
a first lock bolt and a second lock bolt operatively coupled to each other, and biased away from each other, with a separating spring; and
a first locking socket and a second locking socket, each socket operatively coupled to a respective panel of the foldable keyboard, the first socket engageable with the first lock bolt and the second socket engageable with the second lock bolt to resist rotation of the keyboard panels.

17. The keyboard assembly of claim 9, wherein the keyboard is moveable between a locked condition and an unlocked condition in the deployed position, the keyboard rotatable between a keyboard operating position and a tray surface position in the unlocked condition.

18. The keyboard assembly of claim 17, further comprising a biasing element operatively coupled to the keyboard and spring biased toward engagement of at least one pin with an aperture of the steering wheel to place the keyboard in the locked condition.

19. The keyboard assembly of claim 17, wherein the keyboard is rotatable between the keyboard operating position and the tray surface position about a spin axis of the keyboard, the tray surface position aligning a tray surface in substantial alignment with a horizontal plane, the keyboard operating position disposing a keyboard surface at an angle from the horizontal plane, the spin axis extending between the horizontal plane and a plane of the keyboard surface when in the keyboard operating position.

20. The keyboard assembly of claim 19, wherein the spin axis is angled from the horizontal plane one-half the distance that the keyboard surface is angled from the horizontal plane when in the keyboard operating position.
